(19) United States
(12) Patent Application Publication
(10) Pub. No.: US 2026/0307522 A1
(43) Pub. Date: Oct. 8, 2026

(54) SYSTEM AND METHOD FOR CONTROLLING CHARGING OF BATTERY OF ELECTRIFIED VEHICLE

(71) Applicants: Hyundai Motor Company, Seoul (KR); Kia Corporation, Seoul (KR)

(72) Inventors: Yo Han BAEK, Hwaseong-si (KR); Jun Beom WI, Hwaseong-si (KR); Sang Do PARK, Hwaseong-si (KR)

(73) Assignees: Hyundai Motor Company, Seoul (KR); Kia Corporation, Seoul (KR)

(21) Appl. No.: 19/378,067

(22) Filed: Nov. 3, 2025

(30) Foreign Application Priority Data
Apr. 2, 2025 (KR) 10-2025-0042500

(51) Int. Cl. B60L 53/62; B60L 3/00; B60L 15/20; B60L 53/10; B60L 53/24

(52) U.S. Cl. CPC B60L 53/62; B60L 3/0046; B60L 15/2054; B60L 53/11; B60L 53/24; B60L 2210/44

(57) ABSTRACT

A system and method for controlling charging of a battery of an electrified vehicle may alleviate a polarization phenomenon occurring in a battery cell during rapid charging of the battery to shorten a rapid charging time of the battery by short-circuiting a first clutch to cut off power transmission to a front axle during rapid charging of the battery by a rapid charger and driving a first motor in a driving mode rather than a power generation mode in a state where a second clutch is connected for connection with an engine based on the fact that the polarization phenomenon occurring in the battery cell may be alleviated by discharging a pulse current from the battery during rapid charging of the battery by the rapid charger.

### CROSS-REFERENCE TO RELATED APPLICATION

The present application claims, under 35 U.S.C. § 119(a), the benefit of and priority to Korean Patent Application No. 10-2025-0042500 filed on Apr. 2, 2025, the entire contents of which are incorporated herein by reference.

### BACKGROUND

### Field of the Present Disclosure

The present disclosure relates to a system and method for controlling charging of a battery of an electrified vehicle. More particularly, it relates to a system and method for controlling charging of a battery of an electrified vehicle capable of shortening a rapid charging time of the battery.

### Description of Related Art

As is well known, hybrid vehicles, electric vehicles, and hydrogen fuel cell vehicles are powered by electric motors, and such vehicles are referred to as electrified vehicles.

As an example of a powertrain for four-wheel drive of the above-mentioned electrified vehicle, a powertrain in which a front motor is connected to front wheels and a rear motor is connected to rear wheels may be employed.

Furthermore, to realize route diversification of the above-mentioned electrified vehicle, an engine that plays an auxiliary role for battery charging rather than driving may be installed in addition to the front and rear motors, and such an electric vehicle is referred to as an EREV (Extended Range Electrified Vehicle).

The attached FIG. 1 and FIG. 2 are schematic diagrams illustrating a powertrain of the EREV.

As illustrated in FIG. 1 and FIG. 2, the powertrain of the EREV includes a first motor MG1, which is a front motor connected to a front axle 10 in a power-transmissible manner, a second motor MG2, which is a rear motor connected to a rear axle 20 in a power-transmissible manner, and an engine 30 connected to the first motor MG1.

Furthermore, a first clutch 11 is arranged between the first motor MG1 and the front axle 10, and a second clutch 12 is arranged between the first motor MG1 and the engine 30.

Furthermore, the first motor MG1 is connected to a battery 40 by a first inverter 41 in a chargeable and dischargeable manner, and the second motor MG2 is connected to the battery 40 by a second inverter 42 in a dischargeable manner.

In the present instance, current control, i.e., torque control, for the first motor MG1 and the second motor MG2 is performed by the first inverter 41 and the second inverter 42, which are each a type of motor controller, and the second inverter 42 performs power conversion and charging path functions when the battery 40 is charged by a rapid charger, which is an external charger.

Therefore, as illustrated in FIG. 1, in a connected state of the first clutch 11 and a short-circuited state of the second clutch 12, power of the first motor MG1 is transmitted to the front axle 10 and at the same time, power of the second motor MG2 is transmitted to the rear axle 20, so that the vehicle may implement four-wheel drive.

On the other hand, as illustrated in FIG. 2, when the vehicle is driven in the short-circuited state of the first clutch 11 and the connected state of the second clutch 12, if the engine 30 is driven for charging the battery rather than for driving, the first motor MG1 operates as a generator by driving of the engine 30, so that the battery 40 may be charged with generated power of the first motor MG1 through the first inverter 41.

Meanwhile, when a rapid charger 50, which is an external charger, is connected to a charging port of the vehicle to rapidly charge the battery 40 while the vehicle is parked, the battery 40 may be charged with charging power of the rapid charger 50 through the second inverter 42 as illustrated in FIG. 3.

However, the following problems occur when charging the battery using the rapid charger.

During charging of the battery 40 by the rapid charger 50, a polarization phenomenon occurs at an electrode interface of each battery cell included in the battery 40 in proportion to the magnitude of a rapid charging current of the rapid charger 50. The present polarization phenomenon increases a risk of precipitation of lithium contained in the battery cell and causes a voltage drop during charging and discharging of the battery cell, which is a problem acting as an obstacle that hinders shortening of a rapid charging time of the battery.

A the magnitude of the rapid charging current of the rapid charger increases, the polarization phenomenon in each battery cell becomes more severe, and when a voltage of the battery cell easily drops to an upper or lower limit due to the polarization phenomenon occurring in the battery cell, damage or reduction in a lifespan of the battery cell occurs. Therefore, to solve the present problem, the magnitude of the rapid charging current of the rapid charger is reduced to a range in which the battery cell voltage does not reach the upper or lower limit. As a result, the rapid charging time of the battery inevitably increases as the magnitude of the rapid charging current decreases, and ultimately, there is a problem in that the polarization phenomenon occurring in the battery cell acts as an obstacle that hinders shortening of the rapid charging time of the battery.

The above information included in this Background section is only for enhancement of understanding of the background of the present disclosure and therefore it may include information that does not form the related art that is already known in the present country to a person of ordinary skill in the art.

### BRIEF SUMMARY

The present disclosure has been made in an effort to solve the above-described problems associated with related art.

The present disclosure has been made to solve the above-mentioned conventional problems, and various aspects of the present disclosure are directed to providing a system and method for controlling charging of a battery of an electrified vehicle configured for alleviating a polarization phenomenon occurring in a battery cell during rapid charging of the battery to shorten a rapid charging time of the battery by short-circuiting a first clutch to cut off power transmission to a front axle during rapid charging of the battery by a rapid charger and driving a first motor in a driving mode rather than a power generation mode in a state where a second clutch is connected for connection with an engine based on the fact that the polarization phenomenon occurring in the battery cell may be alleviated by discharging a pulse current from the battery during rapid charging of the battery by the rapid charger.

In various aspects of the present discourse, the present disclosure provides a system for controlling charging of a battery of an electrified vehicle, the system including a first motor connected to a front axle to transmit a power of the first motor to the front axle and connected to a battery by a first inverter in a chargeable and dischargeable manner, second motor connected to a rear axle to transmit a power of the second motor to the rear axle and connected to the battery by a second inverter in a dischargeable manner, battery charged by being provided with a charging current of a rapid charger through the second inverter, an engine connected to the first motor, a first clutch disposed between the first motor and the front axle, a second clutch disposed between the first motor and the engine, and a controller configured to determine whether a discharge pulse current is present in a charging target current for rapid charging of the battery based on rapid charging of the battery by the rapid charger, perform a control operation to short-circuit the first clutch based on the discharge pulse current being present in the charging target current, and then perform a control operation to drive the first motor for a certain time period so that a discharge current equivalent to the discharge pulse current is discharged from the battery to the first motor.

In various aspects of the present discourse, the controller may be configured to determine the charging target current provided to the rapid charger based on a rapid charging map, and determine that the discharge pulse current is present in the charging target current based on a discharge current required by other controllers included in the vehicle being present in the determined charging target current.

In various aspects of the present discourse, the controller may be configured to perform a control operation to generate the charging target current as a zero current before performing the control operation to drive the first motor, and then perform a control operation to turn off a first relay connected to an output terminal of the rapid charger or a second relay connected to an input terminal of the second inverter in a state in which the rapid charger is connected to the battery via the second inverter so that rapid charging is allowed.

In various aspects of the present discourse, the controller may be configured to perform a control operation to turn on a third relay connected to an input terminal of the battery to conduct current between the battery and the first inverter so that the discharge current equivalent to the discharge pulse current is discharged from the battery to the first motor through the first inverter based on the control operation to drive the first motor for a predetermined time period.

In various aspects of the present discourse, the controller may be configured to perform a control operation to short-circuit the first clutch and connect the second clutch based on the discharge pulse current being present in the charging target current.

In various aspects of the present discourse, the controller may be configured to perform engine fuel cut control so that the engine exclusively performs a function as a load while driving of the first motor after a control operation to connect the second clutch.

In various aspects of the present discourse, the controller may be configured to perform a control operation to drive the first motor for a certain time period so that a discharge current equivalent to the discharge pulse current is discharged from the battery to the first motor, and then perform precharging control so that a charging current of the rapid charger or a discharge current of the battery flows through a precharge resistor for a certain time period to reduce a voltage difference between the battery and the rapid charger.

In various aspects of the present discourse, as a precharging circuit for the precharging control, a branch line may be conductively connected between a front end and a rear end of a third relay connected between an inlet end of the battery and an outlet end of the second inverter, and a precharge relay and the precharge resistor may be disposed on the branch line.

In various aspects of the present discourse, the precharging control may be achieved by the controller performing a control operation to turn on all of the precharge relay, the third relay, a second relay connected to an inlet end of the second inverter, and a first relay connected to an outlet end of the rapid charger for a predetermined time period, or by performing a control operation to turn on the precharge relay and the third relay and turn off the second relay connected to the inlet end of the second inverter or the first relay connected to the outlet end of the rapid charger.

In various aspects of the present discourse, the controller may be configured to provide a charging target voltage to the rapid charger for rapid charging of the battery after the precharging control, and to perform a control operation to turn off the precharge relay and turn on the third relay, a second relay, and a first relay.

In various aspects of the present discourse, the present disclosure provides a method for controlling charging of a battery of an electrified vehicle including a first motor connected to a front axle to transmit a power of the first motor to the front axle and connected to a battery by a first inverter in a chargeable and dischargeable manner, a second motor connected to a rear axle to transmit a power of the second motor to the rear axle and connected to the battery by a second inverter in a dischargeable manner, a battery charged by being provided with a charging current of a rapid charger through the second inverter, an engine connected to the first motor, a first clutch disposed between the first motor and the front axle, and a second clutch disposed between the first motor and the engine, the method including determining, by a controller, whether a discharge pulse current is present in a charging target current for rapid charging of the battery based on rapid charging of the battery by the rapid charger, driving the first motor for a certain time period after short-circuiting the first clutch by control of the controller based on the discharge pulse current being present in the charging target current, and discharging a discharge current equivalent to the discharge pulse current from the battery to the first motor according to driving of the first motor.

In various aspects of the present discourse, the controller may be configured to determine the charging target current provided to the rapid charger based on a rapid charging map, and determine that the discharge pulse current is present in the charging target current based on a discharge current required by other controllers included in the vehicle being present in the determined charging target current.

In various aspects of the present discourse, before the first motor is driven for the predetermined time period, the controller may perform a control operation to generate the charging target current as a zero current, and then perform a control operation to turn off a first relay connected to an output terminal of the rapid charger or a second relay connected to an input terminal of the second inverter in a state in which the rapid charger is connected to the battery via the second inverter so that rapid charging is allowed.

In various aspects of the present discourse, the controller may perform a control operation to turn on a third relay connected to an input terminal of the battery to conduct current between the battery and the first inverter so that the discharge current equivalent to the discharge pulse current is discharged from the battery to the first motor through the first inverter based on the first motor being driven for a predetermined time period.

In various aspects of the present discourse, the method may further include short-circuiting the first clutch and connecting the second clutch under control of the controller based on the discharge pulse current being present in the charging target current.

In various aspects of the present discourse, engine fuel cut control may be performed by the controller so that the engine exclusively is configured to perform a function as a load while driving of the first motor after the second clutch is connected.

In various aspects of the present discourse, after a discharge current equivalent to the discharge pulse current is discharged from the battery to the first motor according to driving of the first motor, the controller may perform precharging control so that a charging current of the rapid charger flows through a precharge resistor for a certain time period to reduce a voltage difference between the battery and the rapid charger.

In various aspects of the present discourse, a branch line may be conductively connected between a front end and a rear end of a third relay connected between an inlet end of the battery and an outlet end of the second inverter, and a precharge relay and the precharge resistor may be disposed on the branch line so that the controller is configured to perform the precharging control.

In various aspects of the present discourse, the precharging control may be achieved by the controller performing a control operation to turn on all of the precharge relay, the third relay, a second relay connected to an inlet end of the second inverter, and a first relay connected to an outlet end of the rapid charger for a predetermined time period, or by performing a control operation to turn on the precharge relay and the third relay and turn off the second relay connected to the inlet end of the second inverter or the first relay connected to the outlet end of the rapid charger.

In various aspects of the present discourse, the controller may provide a charging target voltage to the rapid charger for rapid charging of the battery after the precharging control, and perform a control operation to turn off a precharge relay and turn on a third relay, a second relay, and a first relay.

Other aspects and exemplary embodiments of the present disclosure are discussed infra.

It is understood that the term “vehicle” or “vehicular” or other similar terms as used herein is inclusive of motor vehicles in general such as passenger vehicles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example, vehicles powered by both gasoline and electricity.

The above and other features of the present disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a schematic diagram illustrating a powertrain of an EREV;

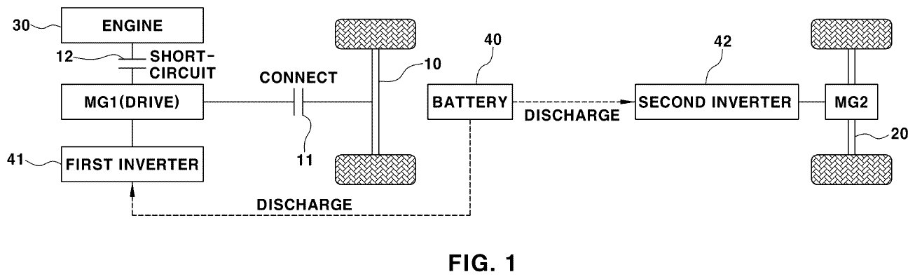

FIG. 2 is a schematic diagram illustrating a state in which a battery is charged with power generated by a first motor among components of the powertrain of the EREV;

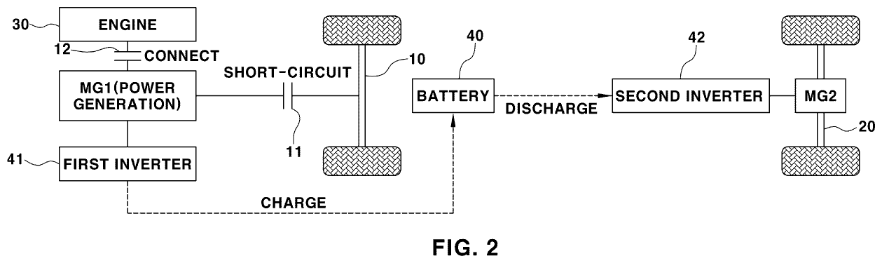

FIG. 3 is a schematic diagram illustrating a state in which a battery is rapidly charged by a rapid charger among the powertrain configurations of an EREV;

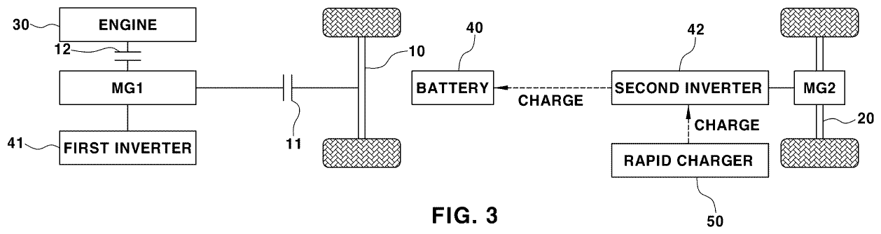

FIG. 4 and FIG. 5 are schematic diagrams illustrating a state in which a discharge current equivalent to a discharge pulse current is discharged from the battery to the first motor by a battery charging control system of an electrified vehicle according to an exemplary embodiment of the present disclosure;

FIG. 6 is a graph illustrating an example in which a discharge pulse current is included in a charging target current when a controller, among components of the battery charging control systems of the electrified vehicle according to an exemplary embodiment of the present disclosure, determines the charging target current based on a rapid charging map;

FIG. 7 is a schematic diagram illustrating a state in which precharging control is performed by the battery charging control system of the electrified vehicle according to an exemplary embodiment of the present disclosure;

FIG. 8 is a schematic diagram illustrating a state in which the battery is charged by the battery charging control system of the electrified vehicle according to an exemplary embodiment of the present disclosure; and

FIG. 9A and FIG. 9B are flowcharts illustrating a method for controlling battery charging of the electrified vehicle according to an exemplary embodiment of the present disclosure.

It should be understood that the appended drawings are not necessarily to scale, presenting a somewhat simplified representation of various exemplary features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Specific structural or functional descriptions presented in the exemplary embodiments of the present specification are only illustrative for describing embodiments according to the concept of the present disclosure, and the embodiments according to the concept of the present disclosure may be implemented in various forms. Furthermore, the present disclosure should not be construed as being limited to the embodiments described herein, and should be understood to include all modifications, equivalents, and substitutes included in the spirit and scope of the present disclosure.

In the present specification, even though terms such as “first,” “second,” etc. may be used to describe various elements, the elements are not limited by these terms. These terms are only used to distinguish one element from another. For example, within the scope not departing from the scope of rights according to the concept of the present disclosure, a first element may be referred to as a second element, and similarly, the second element may be referred to as the first element.

In the present specification, when an element is referred to as being “coupled” or “connected” to another element, the element may be directly coupled or connected to the other element. However, it should be understood that another element may be present therebetween. In contrast, when an element is referred to as being “directly coupled” or “directly connected” to another element, it should be understood that there are no other elements therebetween. Other expressions for describing a relationship between elements, that is, expressions such as “between” and “immediately between” or “adjacent to” and “directly adjacent to”, should be interpreted similarly.

Like reference numerals refer to like elements throughout the present specification. The terminology used herein is for describing the embodiments, and is not intended to limit the present disclosure. In the present specification, a singular expression includes the plural form unless the context clearly dictates otherwise. Referring to expressions “comprises” and/or “comprising” used in the specification, a mentioned component, step, operation, and/or element does not exclude the presence or addition of one or more other components, steps, operations, and/or elements.

Hereinafter, an exemplary embodiment of the present disclosure will be described in detail with reference to the appended drawings.

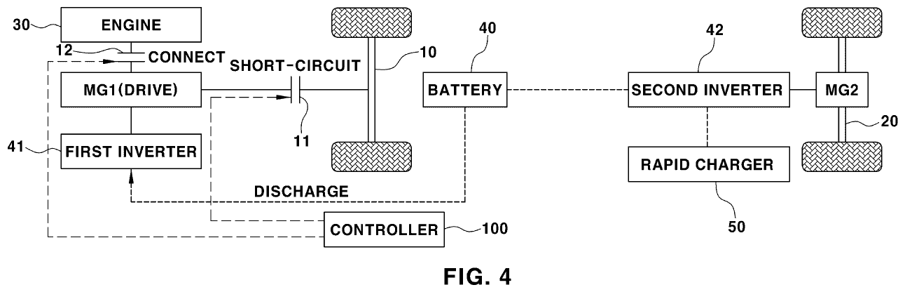

The attached FIG. 4 and FIG. 5 are schematic diagrams illustrating a state in which in which battery charging is performed by a battery charging control system of an electrified vehicle according to an exemplary embodiment of the present disclosure.

As illustrated in FIG. 4 and FIG. 5, a powertrain of an EREV includes a first motor MG1, which is a front motor connected to a front axle 10 in a power-transmissible manner, a second motor MG2, which is a rear motor connected to a rear axle 20 in a power-transmissible manner, and an engine 30 connected to the first motor MG1.

Furthermore, a first clutch 11 is disposed between the first motor MG1 and the front axle 10, and a second clutch 12 is disposed between the first motor MG1 and the engine 30.

Furthermore, the first motor MG1 is connected to the battery 40 by a first inverter 41 in a chargeable and dischargeable manner, and the second motor MG2 is connected to a battery 40 by a second inverter 42 in a dischargeable manner.

Therefore, current control, i.e., torque control, for the first motor MG1 and the second motor MG2 based on discharge power of the battery 40 may be performed by the first inverter 41 and the second inverter 42, which are types of motor controllers, respectively.

In the present instance, the second inverter 42 functions as a charging path when the battery 40 is charged by the rapid charger 50, which is an external charger, so that the battery 40 may be charged with a charging current of the rapid charger 50 through the second inverter 42.

The present disclosure focuses on the fact that a polarization phenomenon occurring in a battery cell acts as an obstacle that hinders reduction of a rapid charging time of a battery in the past, and thus, when a discharge pulse current is present in a charging target current during rapid charging of the battery 40 by the rapid charger 50, the first motor MG1 is driven for a certain time period by control of a controller 100 so that a discharge pulse current is discharged from the battery 40 to the first motor MG1, alleviating the polarization phenomenon occurring in the battery cell and shortening the rapid charging time of the battery.

To the present end, the controller 100 is configured to determine whether a discharge pulse current is present in the charging target current for rapid charging of the battery 40 when the battery 40 is rapidly charged by the rapid charger 50, perform a control operation to short-circuit the first clutch 11 when the discharge pulse current is present in the charging target current, and then perform a control operation to drive the first motor MG1 for a predetermined time period so that the discharge pulse current is discharged from the battery 40 to the first motor MG1.

The controller 100 includes a vehicle control unit (VCU), a battery management unit (BMS), a vehicle charging management system (VCMS), a motor control unit (MCU), an engine control unit (ECU), etc., which are top-level controllers, or may be used as a single integrated controller, and therefore, in the present specification, these controllers will be collectively referred to as a controller 100 for the sake of clear description and understanding of the present disclosure.

The controller 100 is configured to determine a charging target current provided to the rapid charger 50 based on a preset rapid charging map, and is configured to determine that a discharge pulse current is present in the charging target current when there is a discharge current consumed by various controllers included in the vehicle in the determined charging target current.

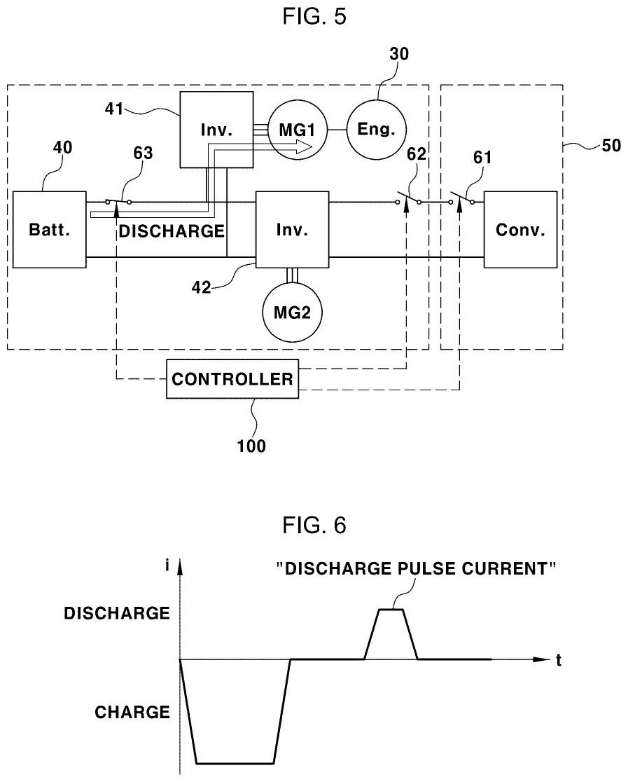

For example, as illustrated in FIG. 6, when there is a positive discharge current (a discharge current provided to various controllers included in the vehicle through a predetermined discharge sequence during rapid charging) in addition to a negative charge current in the charging target current determined based on the rapid charging map, the controller 100 may be configured to determine that there is a discharge pulse current in the charging target current.

A reason why the controller 100 performs a control operation to short-circuit the first clutch 11 is to block driving power of the first motor MG1 from being transmitted to the front axle 10 through the first clutch 11 when the first motor MG1 is driven for a certain time period so that the discharge pulse current is discharged from the battery 40 to the first motor MG1.

The controller 100 is configured to perform a control operation to generate the charging target current as a zero current in a state in which the rapid charger 50 is connected to the battery 40 through the second inverter 42 so that rapid charging may be performed after performing a control operation to short-circuit the first clutch 11 and before performing a control operation to drive the first motor MG1, and then perform a control operation to turn off a first relay 61 connected to an output terminal of the rapid charger 50 or a second relay 62 connected to an input terminal of the second inverter 42.

In the present instance, a reason for generating the charging target current as a zero current is to put an electric circuit formed between the battery 40 and the rapid charger 50 in a no-load state before turning off the first relay 61 or the second relay 62.

The controller 100 is configured to perform a control operation to turn on a third relay 63 connected to an input terminal of the battery 40 to conduct current between the battery 40 and the first inverter 41 so that a discharge current equivalent to the discharge pulse current present in the charging target current is discharged to the first motor MG1 through the first inverter 41 when the first motor MG1 is driven for a predetermined time period.

Furthermore, the controller 100 is configured to perform a control operation to short-circuit the first clutch 11 and perform a control operation to connect the second clutch 12 so that the first motor MG1 and the engine 30 are coaxially connected when the discharge pulse current is present in the charging target current.

In the present instance, a reason for connecting the second clutch 12 to coaxially connect the first motor MG1 and the engine 30 is that the engine 30 acts as a load when driving the first motor MG1 so that the discharge current discharged from the battery 40 to the first motor MG1 is more easily consumed.

The controller 100 is configured to perform engine fuel cut control such that the engine 30 only functions as a load when driving the first motor MG1 after a control operation for connecting the second clutch 12, so that the engine 30 only acts as a load when driving the first motor MG1 and is not actually driven.

In the present way, by focusing on the fact that the polarization phenomenon occurring in the battery cell acts as an obstacle that hinders reduction of a rapid charging time of the battery, when the discharge pulse current is present in the charging target current during rapid charging of the battery 40 by the rapid charger 50, the first motor MG1 is driven for a certain time period so that a discharge current equivalent to the discharge pulse current present in the charging target current is discharged from the battery 40 to the first motor MG1 and consumed. Accordingly, it is possible to reduce the magnitude of the rapid charging current of the rapid charger 50, alleviate the polarization phenomenon occurring in the battery cell, and shorten the rapid charging time of the battery due to alleviation of the polarization phenomenon of the battery cell.

Meanwhile, the controller 100 is configured to perform a control operation to drive the first motor MG1 for a certain time period so that a discharge current equivalent to the discharge pulse current is discharged from the battery 40 to the first motor MG1, and then perform precharging control on a charging current of the rapid charger 50 to reduce a voltage difference between the battery 40 and the rapid charger 50.

In the present instance, a reason for performing the precharging control is to reduce the voltage difference between the battery 40 and the rapid charger 50 so that rapid charging of the battery may be easily performed.

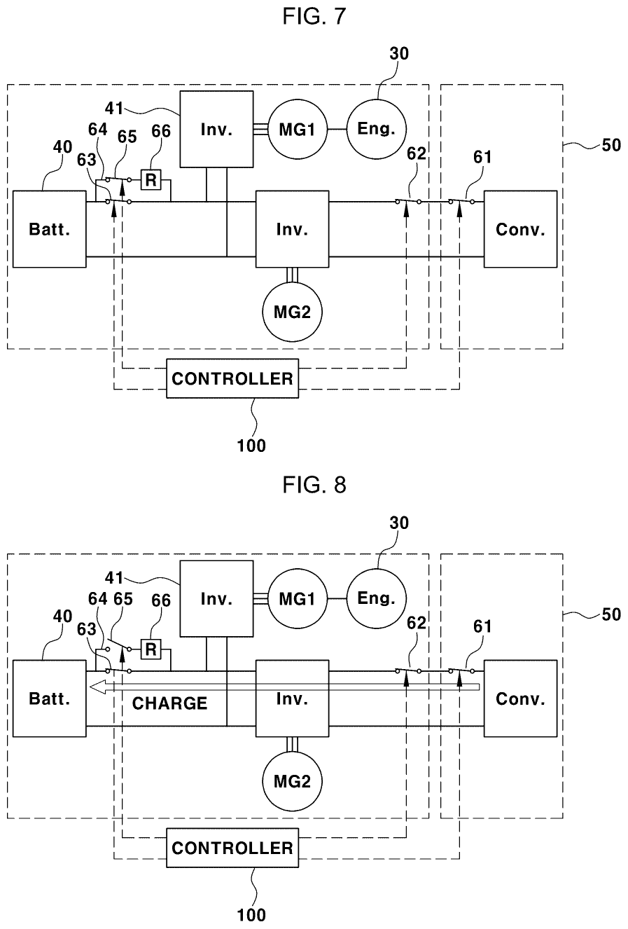

To the present end, a precharging circuit for the precharging control may include a branch line 64 connected between front and rear ends of the third relay 63, and a precharge relay 65 and a precharge resistor 66 sequentially disposed on the branch line 64, as illustrated in FIG. 7.

In detail, the branch line 64 is conductively connected between the front and rear ends of the third relay 63 connected between an inlet end of the battery 40 and an outlet end of the second inverter 42, and the precharge relay 65 and the precharge resistor 66 are sequentially disposed on the branch line 64.

Accordingly, when the magnitude of voltage or current of the rapid charger 50 side is greater than the magnitude of voltage or current of the battery 40 side during precharging control by the controller, a control operation is performed to turn on all of the precharge relay 65, the third relay 63, the second relay 62 connected to an inlet end of the second inverter 42, and the first relay 61 connected to an outlet end of the rapid charger 50 for a certain time period, so that a charging current of the rapid charger 50 may be consumed in the precharge resistor 66 through the second inverter 42 and the precharge relay 65.

Alternatively, when the magnitude of voltage or current of the rapid charger 50 side is less than the magnitude of voltage or current of the battery 40 side during the precharging control by the controller, a control operation is performed to turn on the precharge relay 65 and the third relay 63, and a control operation is performed to turn off the second relay 62 connected to the inlet end of the second inverter 42 or the first relay 61 connected to the outlet end of the rapid charger 50, so that the discharge current of the battery 40 may be consumed in the precharge resistor 66 through the precharge relay 65.

Therefore, by performing precharging control as described above before rapid charging of the battery 40 by the rapid charger 50, the voltage difference between the battery 40 and the rapid charger 50 may be reduced in advance so that rapid charging of the battery may be easily performed.

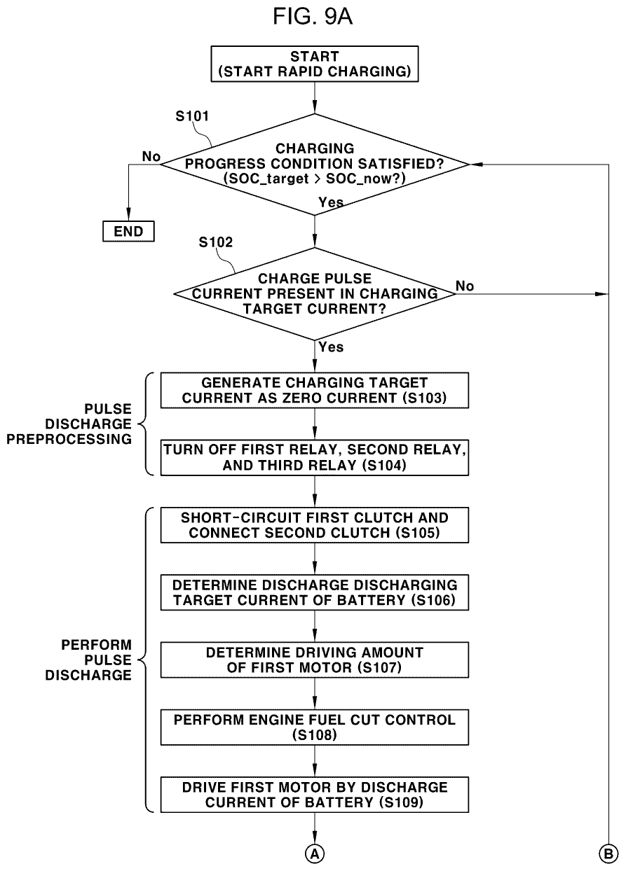

The controller 100 is configured to control to provide a charging target voltage to the rapid charger 50 for rapid charging of the battery after the above-mentioned precharging control, and to perform a control operation to turn off the precharge relay 65 and turn on the third relay 63, the second relay 62, and the first relay 61 as illustrated in FIG. 8.

Therefore, since the voltage difference between the battery 40 and the rapid charger 50 is reduced in advance by the above-mentioned precharging control, the battery 40 may be easily charged with the rapid charging current of the rapid charger 50 through the second inverter 42.

Here, a battery charging control method of the present disclosure based on the above-mentioned configuration will be examined again in order as follows.

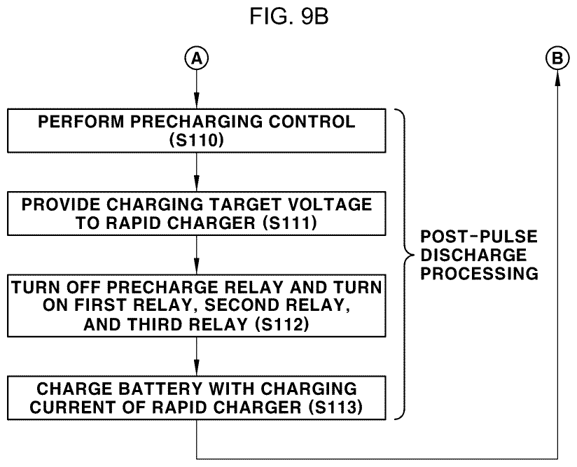

The attached FIG. 9A, FIG. 9B and FIG. 10 are flowcharts illustrating a method for controlling, by the controller 100, battery charging of the electrified vehicle according to an exemplary embodiment of the present disclosure.

First, it is determined, by the controller 100, whether a rapid charging condition of the battery 40 by the rapid charger 50 is satisfied.

To the present end, the controller 100 compares a battery target SOC SOC_target with a battery current SOC SOC_now (S101).

When the battery target SOC SOC_target is greater than the battery current SOC SOC_now as a result of the comparison, it is determined, by the controller 100, that the rapid charging condition of the battery 40 by the rapid charger 50 is satisfied. Next, when the battery 40 is rapidly charged by the rapid charger 50, the controller 100 is configured to determine whether the discharge pulse current is present in the charging target current for rapid charging of the battery 40 (S102).

To the present end, the controller 100 is configured to determine the charging target current provided to the rapid charger 50 based on a preset rapid charging map, and to determine that the discharge pulse current is present in the charging target current when there is a discharge current consumed by various controllers included in the vehicle in the determined charging target current.

In detail, as described above with reference to FIG. 6, the controller 100 may be configured to determine that there is a discharge pulse current in the charging target current when there is a positive discharge current (a discharge current provided to various controllers included in the vehicle through a predetermined discharge sequence during rapid charging) in addition to a negative charge current in the charging target current determined based on the rapid charging map.

Next, as a process before discharging the discharge current equivalent to the discharge pulse current present in the charging target current from the battery 40, i.e., a process before pulse discharge, a control step S103 in which the charging target current is generated as a zero current by control of the controller 100, and a step S104 in which a control operation is performed to turn off the first relay 61 and/or the second relay 62, and the third relay 63 are performed.

In the present instance, a reason for generating the charging target current as a zero current as described above is to put the electric circuit formed between the battery 40 and the rapid charger 50 in a no-load state before turning off the first relay 61 or the second relay 62.

As described above, after a control operation is performed so that the charging target current is generated as a zero current by the controller 100, a control operation is performed to turn off the first relay 61 connected to the output terminal of the rapid charger 50 or the second relay 62 connected to the input terminal of the second inverter 42 in a state in which the rapid charger 50 is connected to the battery 40 via the second inverter 42 so that rapid charging may be performed.

Furthermore, the third relay 63 connected to the input terminal of the battery 40 is turned on by the controller 100 to conduct current between the battery 40 and the first inverter 41 so that the discharge current equivalent to the discharge pulse current from the battery 40 is discharged to the first motor MG1 via the first inverter.

When the present pulse discharge preprocessing procedure is completed, a pulse discharge process is performed to discharge the discharge current equivalent to the discharge pulse current present in the charging target current from the battery 40 to the first motor.

To the present end, a step is first performed in which the first clutch 11 is short-circuited and the second clutch 12 is connected by control of the controller 100 (S105).

Therefore, the first motor MG1 and the front axle 10 are in a state in which power transmission is cut off by short-circuit of the first clutch 11, and the first motor MG1 and the engine 30 are coaxially connected by connection of the second clutch 12.

The controller 100 is configured to determine the target discharge current of the battery 40 by the amount of discharge pulse current present in the discharging target current, i.e., the charging target current (S106), and is configured to determine the driving amount of the first motor MG1 based on the determined target discharge current (S107).

Furthermore, in a state where the first motor MG1 and the engine 30 are coaxially connected by connection of the second clutch 12, engine fuel cut control is performed by the controller 100 so that the engine 30 only performs acting as a load when driving the first motor MG1 (S108).

Subsequently, by controlling the controller 100, the first motor MG1 is driven for a predetermined time period, so that the discharge current equivalent to the discharge pulse current present in the charging target current may be discharged from the battery 40 to the first motor MG1 (S109).

That is, the first motor MG1 may be driven for a certain time period by the discharge current equivalent to the discharge pulse current present in the charging target current from the battery 40.

In the present way, by focusing on the fact that the polarization phenomenon occurring in the battery cell acts as an obstacle that hinders reduction of a rapid charging time of the battery, when the discharge pulse current is present in the charging target current during rapid charging of the battery 40 by the rapid charger 50, the first motor MG1 is driven for a certain time period so that a discharge current equivalent to the discharge pulse current present in the charging target current is discharged from the battery 40 to the first motor MG1 and consumed. Accordingly, it is possible to reduce the magnitude of the rapid charging current of the rapid charger 50, alleviate the polarization phenomenon occurring in the battery cell, and shorten the rapid charging time of the battery due to alleviation of the polarization phenomenon of the battery cell.

When the present pulse discharge process is completed, a post-pulse discharge processing procedure is performed so that the rapid charging of the battery 40 by the rapid charger 50 is performed.

To the present end, first, to reduce the voltage difference between the battery 40 and the rapid charger 50, precharging control is performed by the controller 100 to allow the charging current of the rapid charger 50 to flow to the precharge resistor 66 for a certain time period (S110).

When the magnitude of voltage or current of the rapid charger 50 side is greater than the magnitude of voltage or current of the battery 40 side during precharging control by the controller, a control operation is performed to turn on all of the precharge relay 65, the third relay 63, the second relay 62 connected to the inlet end of the second inverter 42, and the first relay 61 connected to the outlet end of the rapid charger 50 for a predetermined time period, so that the charging current of the rapid charger 50 may be consumed in the precharge resistor 66 through the second inverter 42 and the precharge relay 65.

Alternatively, when the magnitude of voltage or current of the rapid charger 50 side is less than the magnitude of voltage or current of the battery 40 side during precharging control by the controller 100, a control operation is performed to turn on the precharge relay 65 and the third relay 63, and a control operation is performed to turn off the second relay 62 connected to the inlet end of the second inverter 42 or the first relay 61 connected to the outlet end of the rapid charger 50, so that the discharge current of the battery 40 may be consumed in the precharge resistor 66 through the precharge relay 65.

Therefore, by performing precharging control as described above before rapid charging of the battery 40 by the rapid charger 50, the voltage difference between the battery 40 and the rapid charger 50 may be reduced in advance, and accordingly, rapid charging of the battery may be easily performed.

Next, after such precharging control, the charging target voltage is provided to the rapid charger 50 from the controller 100 so that rapid charging of the battery 40 is performed by the rapid charger 50 (S111), and the controller 100 is configured to perform a control operation to turn off the precharge relay 65 and is configured to perform a control operation to turn on the third relay 63, the second relay 62, and the first relay 61 (S112).

Therefore, since the voltage difference between the battery 40 and the rapid charger 50 is reduced in advance by the above-mentioned precharging control, the battery 40 may be easily charged with the rapid charging current of the rapid charger 50 through the second inverter 42 (S113).

Through the above-described problem-solving means, the present disclosure provides the following effects.

According to an exemplary embodiment of the present disclosure, the rapid charging time of the battery disposed on the EREV, a type of electrified vehicle, may be shortened.

In detail, by focusing on the fact that the polarization phenomenon occurring in the battery cell acts as an obstacle that hinders reduction of a rapid charging time of the battery, when the discharge pulse current is present in the charging target current during rapid charging of the battery by the rapid charger, the first motor is driven for a certain time period so that a discharge current equivalent to the discharge pulse current is discharged from the battery to the first motor. Accordingly, it is possible to reduce the magnitude of the rapid charging current of the rapid charger, alleviate the polarization phenomenon occurring in the battery cell, and shorten the rapid charging time of the battery accordingly.

Even though the present disclosure has been described in detail as an exemplary embodiment of the present disclosure, the scope of the present disclosure is not limited to the above-described embodiment, and various modifications and improvements made by those skilled in the art using the basic concept of the present disclosure defined in the following patent claims are included in the scope of the present disclosure.

What is claimed is:

1. A system for controlling charging of a battery of an electrified vehicle, the system comprising:
a first motor connected to a front axle to transmit a power of the first motor to the front axle and connected to a battery by a first inverter in a chargeable and dischargeable manner;
a second motor connected to a rear axle to transmit a power of the second motor to the rear axle and connected to the battery by a second inverter in a dischargeable manner;
a battery charged by being provided with a charging current of a rapid charger through the second inverter;
an engine connected to the first motor;
a first clutch disposed between the first motor and the front axle;
a second clutch disposed between the first motor and the engine; and
a controller determining whether a discharge pulse current is present in a charging target current for rapid charging of the battery based on rapid charging of the battery by the rapid charger, performing a control operation to short-circuit the first clutch based on the discharge pulse current being present in the charging target current, and then performing a control operation to drive the first motor for a predetermined time period so that a discharge current equivalent to the discharge pulse current is discharged from the battery to the first motor.

2. The system of claim 1, wherein the controller determines the charging target current provided to the rapid charger based on a rapid charging map, and concludes that the discharge pulse current is present in the charging target current based on a discharge current required by other controllers included in the vehicle being present in the determined charging target current.

3. The system of claim 1, wherein the controller performs a control operation to generate the charging target current as a zero current before performing the control operation to drive the first motor, and then performs a control operation to turn off a first relay connected to an output terminal of the rapid charger or a second relay connected to an input terminal of the second inverter in a state in which the rapid charger is connected to the battery via the second inverter so that the rapid charging is allowed.

4. The system of claim 1, wherein the controller performs a control operation to turn on a third relay connected to an input terminal of the battery to conduct current between the battery and the first inverter so that the discharge current equivalent to the discharge pulse current is discharged from the battery to the first motor through the first inverter based on the control operation to drive the first motor for a predetermined time period.

5. The system of claim 1, wherein the controller performs a control operation to short-circuit the first clutch and connects the second clutch based on the discharge pulse current being present in the charging target current.

6. The system of claim 5, wherein the controller performs engine fuel cut control so that the engine exclusively performs a function as a load while driving of the first motor after a control operation to connect the second clutch.

7. The system of claim 1, wherein the controller performs a control operation to drive the first motor for a predetermined time period so that a discharge current equivalent to the discharge pulse current is discharged from the battery to the first motor, and then performs precharging control so that a charging current of the rapid charger or a discharge current of the battery flows through a precharge resistor for a predetermined time period to reduce a voltage difference between the battery and the rapid charger.

8. The system of claim 7, wherein, as a precharging circuit for the precharging control, a branch line is conductively connected between a front end and a rear end of a third relay connected between an inlet end of the battery and an outlet end of the second inverter, and a precharge relay and the precharge resistor are disposed on the branch line.

9. The system of claim 8, wherein the precharging control is achieved by the controller performing a control operation to turn on all of the precharge relay, the third relay, a second relay connected to an inlet end of the second inverter, and a first relay connected to an outlet end of the rapid charger for a predetermined time period, or by performing a control operation to turn on the precharge relay and the third relay and turn off the second relay connected to the inlet end of the second inverter or the first relay connected to the outlet end of the rapid charger.

10. The system of claim 7, wherein the controller provides a charging target voltage to the rapid charger for the rapid charging of the battery after the precharging control, and performs a control operation to turn off the precharge relay and turn on the third relay, a second relay, and a first relay.

11. A method for controlling charging of a battery of an electrified vehicle including a first motor connected to a front axle to transmit a power of the first motor to the front axle and connected to a battery by a first inverter in a chargeable and dischargeable manner, a second motor connected to a rear axle to transmit a power of the second motor to the rear axle and connected to the battery by a second inverter in a dischargeable manner, a battery charged by being provided with a charging current of a rapid charger through the second inverter, an engine connected to the first motor, a first clutch disposed between the first motor and the front axle, and a second clutch disposed between the first motor and the engine, the method comprising:
determining, by a controller, whether a discharge pulse current is present in a charging target current for rapid charging of the battery based on the rapid charging of the battery by the rapid charger;
driving the first motor for a predetermined time period after short-circuiting the first clutch by control of the controller based on the discharge pulse current being present in the charging target current; and
discharging a discharge current equivalent to the discharge pulse current from the battery to the first motor according to driving of the first motor.

12. The method of claim 11, further including:
determining, by the controller, the charging target current provided to the rapid charger based on a rapid charging map, and concluding, by the controller, that the discharge pulse current is present in the charging target current based on a discharge current required by other controllers included in the vehicle being present in the determined charging target current.

13. The method of claim 11, further including: before the first motor is driven for the predetermined time period, performing, by the controller, a control operation to generate the charging target current as a zero current, and then performing a control operation to turn off a first relay connected to an output terminal of the rapid charger or a second relay connected to an input terminal of the second inverter in a state in which the rapid charger is connected to the battery via the second inverter so that the rapid charging is allowed.

14. The method of claim 11, further including:
performing, by the controller, a control operation to turn on a third relay connected to an input terminal of the battery to conduct current between the battery and the first inverter so that the discharge current equivalent to the discharge pulse current is discharged from the battery to the first motor through the first inverter based on the first motor being driven for a predetermined time period.

15. The method of claim 11, further including short-circuiting the first clutch and connecting the second clutch under control of the controller based on the discharge pulse current being present in the charging target current.

16. The method of claim 15, further including performing, by the controller, engine fuel cut control so that the engine exclusively performs a function as a load during driving of the first motor after the second clutch is connected.

17. The method of claim 11, further including:
after a discharge current equivalent to the discharge pulse current is discharged from the battery to the first motor according to driving of the first motor, performing, by the controller, precharging control so that a charging current of the rapid charger flows through a precharge resistor for a predetermined time period to reduce a voltage difference between the battery and the rapid charger.

18. The method of claim 17, wherein a branch line is conductively connected between a front end and a rear end of a third relay connected between an inlet end of the battery and an outlet end of the second inverter, and a precharge relay and the precharge resistor are disposed on the branch line so that the controller performs the precharging control.

19. The method of claim 18, further including:
for performing the precharging control, performing, by the controller, a control operation to turn on all of the precharge relay, the third relay, a second relay connected to an inlet end of the second inverter, and a first relay connected to an outlet end of the rapid charger for a predetermined time period, or performing, by the controller, a control operation to turn on the precharge relay and the third relay and turn off the second relay connected to the inlet end of the second inverter or the first relay connected to the outlet end of the rapid charger.

20. The method of claim 17,, further including:
providing, by the controller, a charging target voltage to the rapid charger for the rapid charging of the battery after the precharging control, and performing, by the controller, a control operation to turn off a precharge relay and turn on a third relay, a second relay, and a first relay.
